(19) United States
(12) Patent Application Publication
(10) Pub. No.: US 2023/0230132 A1
(43) Pub. Date: Jul. 20, 2023

(54) SYSTEM AND METHOD OF DEPLOYING NEURAL NETWORK BASED DIGITAL ADVERTISING

(71) Applicant: TouchBistro Inc., Toronto (CA)

(72) Inventor: Matthew F. Zibell, Toronto (CA)

(21) Appl. No.: 17/579,243

(22) Filed: Jan. 19, 2022

(51) Int. Cl. G06Q 30/02; G06N 3/08; G06N 3/04

(52) U.S. Cl. CPC G06Q 30/0277; G06N 3/084; G06N 3/088; G06N 3/0454

(57) ABSTRACT

Systems and methods of training and deploying a machine learning neural network in digital advertising. The method comprises receiving a plurality of input datasets at respective ones of a plurality of input layers of the neural network, the neural network being instantiated in one or more processors. The neural network comprises an output layer interconnected to the plurality of input layers via a set of intermediate layers, each of the input datasets being associated with a respective digital ad input attribute, ones of the intermediate layers being configured in accordance with an initial matrix of weights; and training the neural network in accordance with the plurality of input layers based upon recursively adjusting the initial matrix of weights by backpropogation in generating, at the output layer, at least one digital ad output attribute in accordance with diminishment of an error matrix computed at the output layer of the neural network.

### TECHNICAL FIELD

The disclosure herein relates to artificial intelligence machine learning networks in digital advertising and deployment thereof.

### BACKGROUND

With increasing network traffic, networking systems have experienced expanded placement of digital advertisements for products and services. Merchants commonly deploy digital advertisements on a merchant's web or profile page, post digital advertisements within newsfeeds of users, making advertisement (ad) content interactively accessible to many types of computing and mobile communication devices. In addition to placing such digital advertisements, networking systems commonly enable merchants and advertisers to provide more detailed information concerning products and services featured in digital advertisements, including videos or images. In some digital advertisements, hyperlinks direct a web browser or mobile application to a merchant or advertiser's web page.

Despite the increased adoption of digital advertising in networked systems, conventional digital communication techniques provide limited mechanisms for tracking a return on investment (ROI) associated with digital ad expenditures promoting products and services, or for tracking effectiveness across different digital ad channel types, promotion types and content types used in the digital advertising.

### BRIEF DESCRIPTION OF THE DRAWINGS

FIG. 1 illustrates, in an example embodiment, a cloud-based system for artificial intelligence (AI) based neural network training related to deployment of digital advertising.

FIG. 2 illustrates, in an example embodiment, an architecture of a cloud-based server computing system for AI based neural network training in deployment of digital advertising.

FIG. 3, in an example embodiment, a diagrammatic representation for AI based neural network in deployment of digital advertising.

FIG. 4 illustrates, in an example embodiment, a method of AI based neural network training in deployment of digital advertising.

FIG. 5 illustrates, in an example embodiment, a method of operation in a cloud-based server computing system for deployment of AI based neural network in digital advertising.

### DETAILED DESCRIPTION

Embodiments herein address shortcomings associated with timely and accurate tracking and of consumer interactions with digital advertising in its myriad forms. In particular, embodiments herein advantageously enable tracking of return on investment (ROI) results associated with digital ad expenditures and allows identification of particular digital ad attributes which can be deployed in optimally tailoring a digital ad, or a digital ad program, likely to provide optimal ROI results. Embodiments herein provide such advantages further based on recognizing adequacy and sufficiency of training datasets related to digital advertising (digital ad) as applied to machine learning neural network training and deployment models.

In embodiments, the digital ad as referred to herein can include not just strictly commercial digital advertisements as posted or distributed, but can also more broadly include other content that can be pertinent to an entity's commercial success, including product reviews, services reviews and similar posted social commentary; for example, reviews of a restaurant, or of restaurant services, sourced from social commentary communication channels, including but not limited to Instagram and Facebook postings. In some embodiments, such restaurant reviews can include content excerpted or adopted to provide a qualitative basis for an associated customer satisfaction input attribute, and review ratings, such as 5-stars or 4-stars ratings, can provide a quantitative basis for the associated customer satisfaction input attribute.

In particular, artificial intelligence (AI) and machine learning neural networks disclosed herein encode layered representation of digital ad input attributes data, as modeled or represented via input layers of the neural network. The hierarchical feature representation of neural networks enable encoding of digital ad input dataset features. A deep learning architecture automatically learns the hierarchy of the feature representations where progressively complex digital ad attributes can be applied as input features to the input layers and other neural network layer data encodings as disclosed herein.

Among other benefits, solutions herein enable neural network training in accordance with dynamically selected input layers of the neural network, thereby leveraging in real-time only the neural network layers that are trained in accordance with availability of sufficient labelled datasets. Embodiments herein recognize that input datasets for at least some of those digital ad input attributes may not be sufficient to provide a fully trained neural network for deployment. Embodiments herein, however, also recognize that as more data is acquired while using the neural network model in deployment stages, neural network input layers' data sufficiency thresholds associated with formerly-insufficient data adequacy of input dataset attributes can be fulfilled dynamically in real-time as deployment progresses. The term dynamically as used herein refers to actions achieved in real time during execution of the neural network in training and also in deployment phases.

As described herein, the neural networks, in embodiments, refer to an AI based neural network, including machine learning and deep learning models. In a particular embodiment, the neural network model herein may be implemented as a convolution neural network (CNN). In some embodiments, implementations may be deployed in accordance with other neural network models, including but not limited to a recurrent neural network (RNN) model, based on techniques disclosed herein.

In accordance with a first example embodiment, provided is a method of training a machine learning neural network for deployment in digital advertising. The method comprises receiving a plurality of input datasets at respective ones of a plurality of input layers of the neural network, the neural network being instantiated in one or more processors and comprising an output layer interconnected to the plurality of input layers via a set of intermediate layers, each of the plurality of input datasets being associated with a respective digital advertising (digital ad) input attribute, ones of the set of intermediate layers being configured in accordance with an initial matrix of weights. The method further includes training the neural network in accordance with the respective ones of the plurality of input layers based at least in part upon recursively adjusting the initial matrix of weights by backpropogation in generating, at the output layer, at least one digital ad output attribute in accordance with diminishment of an error matrix computed at the output layer of the neural network.

Embodiments disclosed herein include techniques for training the convolution neural network based at least in part upon recursively adjusting an initial matrix of assigned weights associated with the intermediate layers by backpropogation. In such embodiments, the weight matrix associated with respective intermediate layer is recursively computed based on the error function and initially assigned weight matrix, thereby training respective layers of the multiple intermediate layers. The training may be based either on a supervised machine learning approach or an unsupervised machine learning approach, and in some embodiments any combination of supervised and unsupervised learning may be applied.

Supervised learning as used herein refers to methods of training a machine learning (ML) algorithm based on labelled input dataset streams, while guiding the ML algorithm model in learning in accordance with expert knowledge in digital advertising applied to provide feedback in effectiveness of a given digital ad, whereby the ML algorithm learns the mapping function from the input features to output attributes. Dataset labels applied via the training can be related to indicators associated with success of the given digital ad, such as, for example, cumulative sales revenue and ROI, or other attributes as listed among output attributes 302.

In an unsupervised learning embodiment, clustering techniques or algorithms can be applied to find natural groups or clusters in the digital ad feature space and interpret the input data. The unsupervised learning technique, in an embodiment, employs a clustering algorithm that identifies one or more clusters in digital ad input features or attributes and applies respective dataset labels to the input features of the dataset.

In accordance with a second example embodiment, a non-transitory medium storing instructions executable in a processor of a server computing device is provided. The instructions, when executed in one or more processors, cause operations comprising receiving a plurality of input datasets at respective ones of a plurality of input layers of a neural network, the neural network being instantiated in one or more processors and comprising an output layer interconnected to the plurality of input layers via a set of intermediate layers, each of the plurality of input datasets being associated with a respective digital advertising (digital ad) input attribute, ones of the set of intermediate layers being configured in accordance with an initial matrix of weights; and training the neural network in accordance with the respective ones of the plurality of input layers based at least in part upon recursively adjusting the initial matrix of weights by backpropogation in generating, at the output layer, at least one digital ad output attribute in accordance with diminishment of an error matrix computed at the output layer of the neural network.

In accordance with a third example embodiment, a server computing system is provided. The server computing system comprises one or more processors and a non-transitory memory storing instructions. The instructions, when executed in the one or more processors, cause operations comprising receiving a plurality of input datasets at respective ones of a plurality of input layers of the neural network, the neural network being instantiated in one or more processors and comprising an output layer interconnected to the plurality of input layers via a set of intermediate layers, each of the plurality of input datasets being associated with a respective digital advertising (digital ad) input attribute, ones of the set of intermediate layers being configured in accordance with an initial matrix of weights; and training the neural network in accordance with the respective ones of the plurality of input layers based at least in part upon recursively adjusting the initial matrix of weights by backpropogation in generating, at the output layer, at least one digital ad output attribute in accordance with diminishment of an error matrix computed at the output layer of the neural network.

One or more embodiments described herein provide that methods, techniques, and actions performed by a computing device are performed programmatically, or as a computer-implemented method. Programmatically by way of software applications, as referred to herein, means through the use of code or computer-executable instructions. These instructions can be stored in one or more memory resources of the computing device.

Furthermore, one or more embodiments described herein may be implemented through the use of logic instructions that are executable by one or more processors of a computing device, including a server computing device. These instructions may be carried on a computer-readable medium. In particular, machines shown with embodiments herein include processor(s) and various forms of memory for storing data and instructions. Examples of computer-readable mediums and computer storage mediums include portable memory storage units, and flash memory. A server computing device as described herein utilizes processors, memory, and logic instructions stored on computer-readable medium. Embodiments described herein may be implemented in the form of computer processor-executable logic instructions or programs stored on computer memory mediums.

### System Description

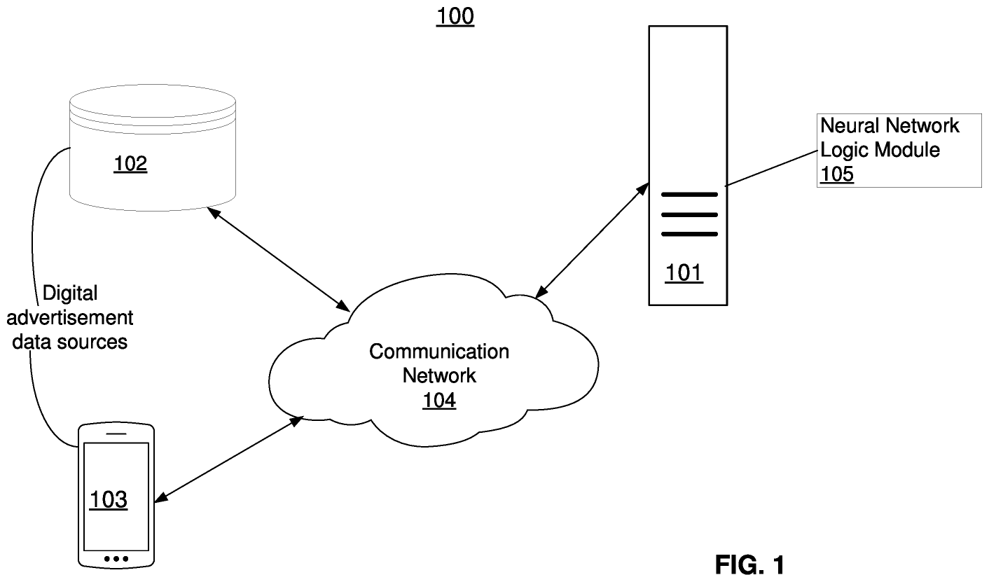

FIG. 1 illustrates, in an example embodiment, a cloud-based system 100 for artificial intelligence (AI) based neural network training and deployment of digital advertising. Server computing device 101 includes neural network logic module 105 embodied and instantiated in accordance with computer processor-executable instructions stored within a non-transitory memory. Server computing device 101 is in communication via communication network 104, in some embodiments a cloud-based server system, with mobile computing device 103, which can be mobile computing and communication devices carried by consumers or customers of services and products being advertised. Database 102 can, for example, store accumulative digital advertising data that is communicatively accessible to server computing device 101, and also receive digital ad data transmitted to and from mobile computing device 103 based on consumer or customer interactions with digital ads presented thereon. In embodiments, mobile computing device 103 is representative of multiple computing devices including tablets, mobile phones and laptop and desktop computers.

In particular embodiments, server computing device 101 may be a unitary server or may be a distributed server spanning multiple computers or multiple datacenters. Systems, engines, or modules may be of various types, such as, for example and without limitation, web server, news server, mail server, message server, advertising server, file server, application server, exchange server, database server, or proxy server. In particular embodiments, each system, engine or module may include hardware, software, or embedded logic components or a combination of two or more such components for carrying out the appropriate functionalities implemented or supported by their respective servers. A database server is generally capable of providing an interface for managing data stored in one or more data stores or databases 102. The term “server” as used herein broadly encompasses other comparable but varying server computing device types, including raw data servers.

Mobile computing device 103 can be representative of computing devices such as a tablet computing device, a mobile phone or a desktop or laptop computing device in some embodiments, enabling user interaction with digital advertising applications and content stored and executed thereon. In some embodiments, the advertising ad content may be accessed and downloaded from server computing device 101 via communication network 104. Mobile computing device 103 can be used to enable user interaction with digital ad content, such as accessing and redeeming advertisement promotions, with records of the user interactions being recorded via server computing device 101 for use in conjunction with neural network logic module 105.

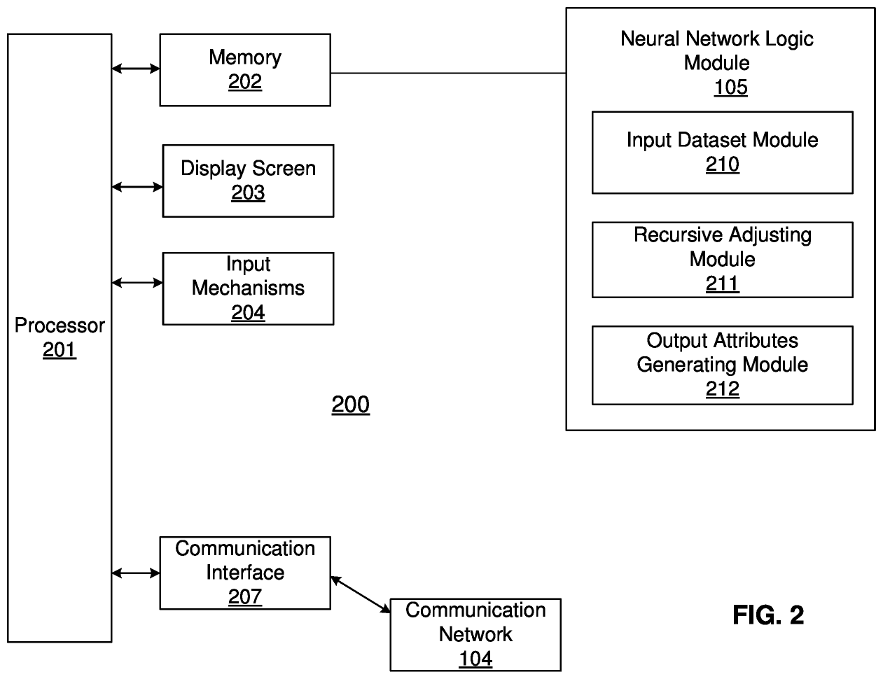

FIG. 2 illustrates, in an example embodiment, an architecture 200 of a cloud-based server computing system for AI based neural network training in deployment of digital advertising. Server computing device 101 includes processor 201, memory 202, display screen 203, input mechanisms 204 such as a keyboard or software-implemented touchscreen input functionality, and communication interface 207 for communicating via communication network 104. Memory 202 may comprise any type of non-transitory system memory, storing instructions that are executable in processor 201, including such as a static random access memory (SRAM), dynamic random access memory (DRAM), synchronous DRAM (SDRAM), read-only memory (ROM), or any combination thereof.

Neural network logic module 105 includes processor-executable instructions stored in memory 202 of server computing device 101, the instructions being executable in processor 201. Neural network logic module 105 may comprise portions or sub-modules including dataset input module 210, recursive adjusting module 211, and output attributes generating module 212.

Processor 201 uses executable instructions of input datasets module 210 to generate, via data pre-processing operations, from a datastream of digital ad attributes. In some embodiments, the digital ad input data can be pre-processed in accordance with data normalization operations, and can include image pre-processing, filtering and extraction of text data, or any combination thereof, as provided to the input dataset layers of the neural network. The data pertaining to the dataset of ad digital input features can include digital image data, text data, parametric measurement data and any combination thereof.

Processor 201 uses executable instructions stored in recursive adjusting module 211 to train the neural network in accordance with the respective ones of set of input layers based at least in part upon adjusting the initial matrix of weights in generating, at the output layer, at least one digital ad output attribute. In some embodiments, the output attribute relates to a benefit or a result that would be a desired outcome of the digital ad or promotion. In embodiments, the adjusting comprises recursively adjusting the initial matrix of weights by backpropogation in generating the output attributes. Generating the output attribute proceeds, based on the recursively adjusting, in accordance with diminishment of an error matrix computed at the output layer of the neural network. In embodiments, the backpropagation comprises a backward propagation of errors in accordance with an error matrix as computed at the output layer, the errors being distributed backwards throughout the weights of the neural network intermediate layers.

In embodiments, the training model may be implemented in accordance with executable instructions stored in recursive adjusting module 211. The neural network, in one embodiment, is configured with a set of input layers, an output layer, and one or more intermediate layers connecting the input and output layers. In embodiments, the input layers are associated with input features or input attributes that relate to digital ad data, such as, but not limited to, digital ad data sourced, created or accessible via mobile computing device 103. Output attributes generating module 212 can present resultant output attributes at user interfaces including display screen 203 or other display interface devices that enable selection of specific ones of the output attributes generated.

In some aspects, a data qualification threshold relates to one or more of a data source category, a time proximity of data collection, a data density and a confidence level associated with the input attribute data provided to the set of input layers.

The data density, as referred to herein, may be an amalgamate of a number of images, the quality or resolution of the images, or a combination thereof, as rendered in a digital ad input data. The data density, in an embodiment, is a measure of a quality and sufficiency of the input data for training the neural network to reliably and accurately generate digital ad output attributes, once the neural network as trained is deployed.

In this manner, in accordance with the data source category, the time proximity of data collection, the data density and a confidence level associated with the input feature data provided to the set of input layers, only input layers having sufficient or high quality input data are selected for activation with one or more intermediate layers in creating the trained neural network. The remaining input layers having data density or other attributes below the data threshold can be de-activated from neural network node computations, at least in part because input data attributes below the threshold may not justify consumption of compute resources, including processor and memory resources.

In additional embodiments, as the input data attributes, such as data source category, the time proximity of data collection, the data density, rise to the level of a respective threshold requirement, the respective input layers which were previously de-activated can now be activated via being dynamically linked to establish active nodes of the intermediate layers for compute operations in the neural network, and are thus re-engaged in the neural network training. In embodiments, with regard to the time proximity of data collection, more recent data can belayer selecting module prioritized, or weighted more heavily, than older data. With regard to the data source category, data collected in more controlled or monitored contexts may be weighted more heavily, or accorded a higher quality status, compared to more routinely collected digital ad data.

In the particular embodiment of a convolution neural network model, the convolution operation typically embodies two parts of inputs: (i) input feature map data, and (ii) a weight, also referred to as output filter, or kernel. Given the input channel data with W(Width)×H(Height)×IC data cube and RxSxIC filter, the output of direct convolution may be formulated as:

$${y}_{w , h} = {\sum }_{r = 0}^{R - 1} {\sum }_{s = 0}^{S - 1} {\sum }_{c = 0}^{C - 1} {x}_{( w + r ) , ( h + s ) , c} * {w}_{r , s , c}$$

where:
X=input data/input feature/input feature map
w=width of the input or output data
h=height of the input or output data
R=weight size (width)
S=weight size (height)
C=number of input channels
Y=output data/output feature/output feature map
W=filter/kernel/weight

Machine learning inference and training networks typically are configured to include many convolution layers. Typically, the output of one convolution layer becomes the input of the next convolution layer. For each input channel, the filter, or weight, are convoluted with data and generates output data. The same location of data of all the input channels are summed together and generate the output data channel. The weight is applied to detect a particular defect feature or type based on an input data stream of digital parameters.

Each output channel of the convolution model is represented by an output filter or weight used to detect one particular feature or pattern of the input feature data stream. Convolution networks may be constituted of many output filters or weights for each layer of the convolution model corresponding to respective features or patterns in the input attributes data stream.

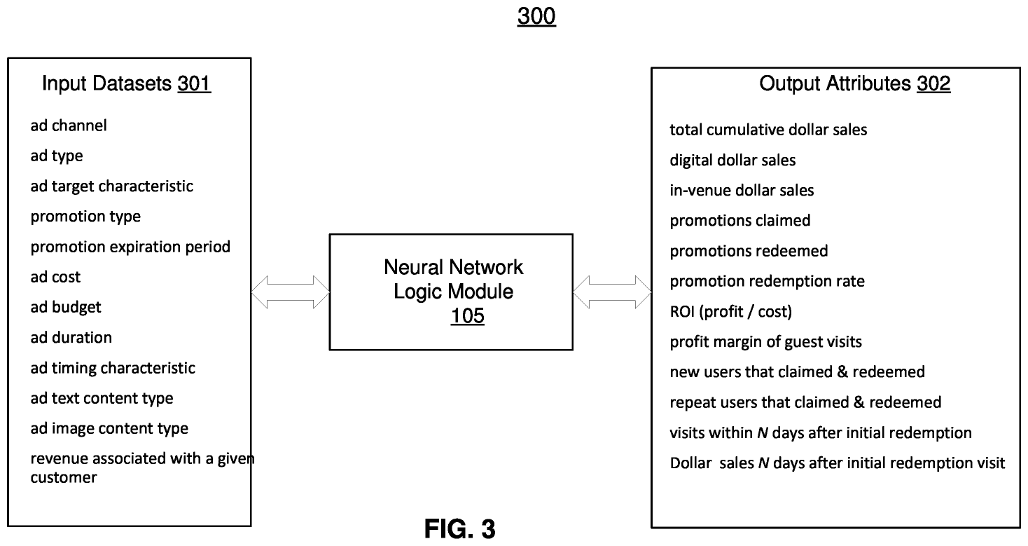

FIG. 3 illustrates, in example embodiment 300, a diagrammatic representation of an AI based neural network in deployment of digital advertising. In embodiments, the input attribute or features data may include image data, text data, parametric measurement data, and any combination thereof. In illustrative examples, input datasets 301 provide data associated with input features or input attributes of digital advertising including, but not necessarily limited to:
ad channel type (Facebook, Google, Instagram, etc.)
ad type (display, text, video, image)
ad targeting demographics (targeted to customers or users within a certain geographic location, also target based on age, gender, education, job title, prior behaviors, interests, hobbies, financial income and earnings, etc.)
promotion type (free appetizer, 10% off, buy an entree get a free dessert, etc.)
promotion expiration (# of days)
ad cost (per click, per impression, etc.)
ad budget
ad duration (# days)
ad timing (month, season of the year, etc.)
ad text content (new restaurant announcement, new item, drive first time visits, event announcement, etc.)
ad image content (food, drink, restaurant interior, happy guests, etc.)

In embodiments, a digital ad as referred to herein can include not just strictly commercial digital advertisements as posted or distributed, but can also more broadly include other content that can be pertinent to an entity's commercial success, including product reviews, services reviews and similar posted social commentary; for example, reviews of a restaurant, or of restaurant services, sourced from social commentary communication channels, such as Instagram and Facebook postings. In some embodiments, such restaurant reviews can include content excerpted or adopted to provide a qualitative basis for an associated customer satisfaction input attribute, and review ratings, such as 5-stars or 4-stars ratings, can provide a quantitative basis for the associated customer satisfaction input attribute.

Neural network logic module 105, in one embodiment, can be a convolutional neural network, though alternate architectures, including a recurrent neural network model, may be applied. Embodiments disclosed herein include techniques for training the convolution neural network, based on a supervised machine learning approach, an unsupervised machine learning approach, or any combination of both. In embodiments, training the convolutional neural network is accomplished via recursively adjusting an initial matrix of assigned weights associated with the intermediate layers by backpropogation. In such embodiments, the weight matrix associated with a respective intermediate layer is recursively computed based on the error function and initially assigned weight matrix, thereby training respective layers of the multiple intermediate layers.

Supervised learning as used herein refers to methods of training a machine learning (ML) algorithm based on labelled input dataset streams, while guiding the ML algorithm model in learning in accordance with expert knowledge in digital advertising applied to provide feedback in effectiveness of a given digital ad, whereby the ML algorithm learns the mapping function from the input features to output attributes. Dataset labels applied via the training can be related to indicators associated with success of the given digital ad, such as, for example, cumulative sales revenue and ROI, or other attributes as listed among output attributes 302.

In unsupervised learning embodiments, clustering techniques or algorithms can be applied to find natural groups or clusters in the digital ad feature space and interpret the input data. The unsupervised learning technique, in an embodiment, employs a clustering algorithm that identifies one or more clusters in digital ad input features or attributes and applies respective dataset labels to the input features of the dataset.

Output attributes 302 generated from deployment of neural network logic module 105 as associated with any given digital ad include such as:
accumulative or total dollar sales revenue
   associated with accumulative visits to a physical (“brick-and-mortar”) store
   associated with accumulative visits to a website associated with e-commerce transactions
   from a combination of accumulative visits to physical (“brick-and-mortar”) stores as well as websites for e-commerce transactions
      by a given customer
      by an identified or target customer demographic
digital dollar sales
in-venue or “brick-and-mortar” dollar sales
promotions claimed
promotions redeemed
promotion redemption rate
ROI (profit vs. ad cost)
profit margin of guest visits (profit/revenue)
new or first-time users that claimed & redeemed
repeat users that claimed & redeemed
visits within 30/60/90/120 days after initial redemption visit
dollar sales revenue 30/60/90/120 days after initial redemption visit
accumulative revenue dollar value associated with a given customer

Methodology

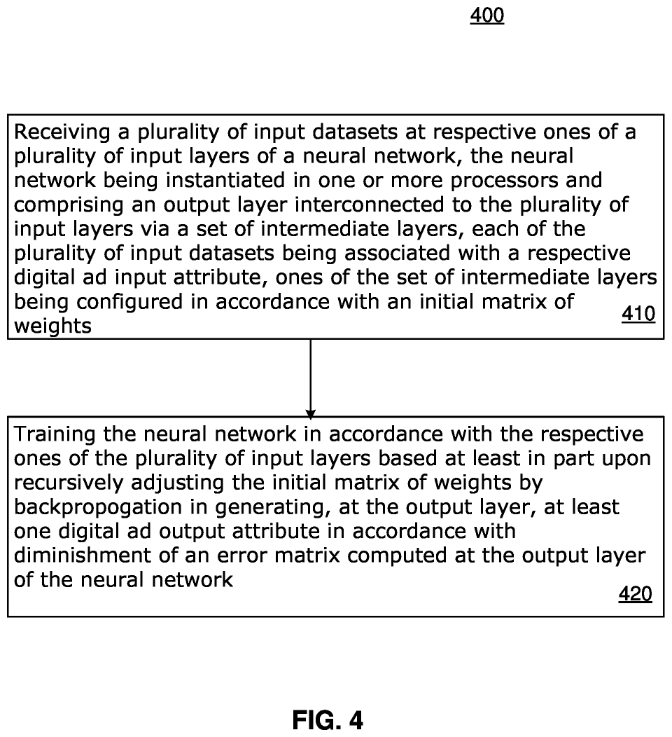

FIG. 4 illustrates, in one example embodiment, method 400 of AI based neural network training in deployment of digital advertising. Examples of method steps described herein relate to the use of server computing device 101 for implementing the techniques described. Method 400 embodiment depicted can be performed by one or more processors 201 of server computing device 101. In describing and performing the embodiments of FIG. 4, the examples of FIG. 1, FIG. 2 and FIG. 3 are incorporated for purposes of illustrating suitable components or elements for performing a step or sub-step being described. According to one embodiment, the techniques are performed by neural network logic module 105 of server computing device 101 in response to the processor 201 executing one or more sequences of software logic instructions that constitute neural network logic module 105.

In embodiments, neural network logic module 105 may include the one or more sequences of instructions within sub-modules including input datasets module 210, recursive adjusting module 211 and output attributes generating module 212. Such instructions may be read into memory 202 from machine-readable medium, such as memory storage devices. In executing the sequences of instructions contained in input datasets module 210, and recursive adjusting module 211 of neural network logic module 105 in memory 202, processor 201 performs the process steps described herein. In alternative implementations, at least some hard-wired circuitry may be used in place of, or in combination with, the software logic instructions to implement examples described herein. Thus, the examples described herein are not limited to any particular combination of hardware circuitry and software instructions.

At step 410, processor 201 executes instructions of dataset input module 210 to receive, in a memory of server computing device 101, a plurality of input datasets at respective ones of a plurality of input layers of the neural network, the neural network being instantiated in one or more processors and comprising an output layer interconnected to the plurality of input layers via a set of intermediate layers, each of the plurality of input datasets being associated with a respective digital advertisement (digital ad) input attribute, ones of the set of intermediate layers being configured in accordance with an initial matrix of weights.

At step 420, processor 201 of server computing device 101 executes instructions included in recursive adjusting module 211 to train the neural network in accordance with the respective ones of the plurality of input layers based at least in part upon recursively adjusting the initial matrix of weights by backpropogation in generating, at the output layer, at least one digital ad output attribute in accordance with diminishment of an error matrix computed at the output layer of the neural network. Output attributes generating module 212 can present resultant output attributes at user interfaces including display screen 203 or other display interface devices that enable selection of specific ones of the output attributes generated.

In some embodiments, the digital ad input datasets may be such as, but not limited to, a digital ad channel, a digital ad type, a customer demographic target characteristic, a digital ad promotion type, a promotion expiration period, a digital ad cost, a digital ad budget, a digital ad duration, a digital ad timing characteristic, a digital ad text content type and a digital ad image content type.

In some aspects, the digital ad output attributes can include total cumulative dollar sales associated with the digital ad, digital dollar sales revenue, in-venue dollar sales revenue, a number of promotions claimed, a number of promotions redeemed, a promotion redemption rate, a return on investment (ROI) in view of profit versus cost, a profit margin of guest visits, a number of new users that claimed & redeemed, a number of repeat users that claimed & redeemed, a number of visits within 30/60/90/120 days after initial redemption visit, and dollar sales revenue 30/60/90/120 days after an initial redemption visit.

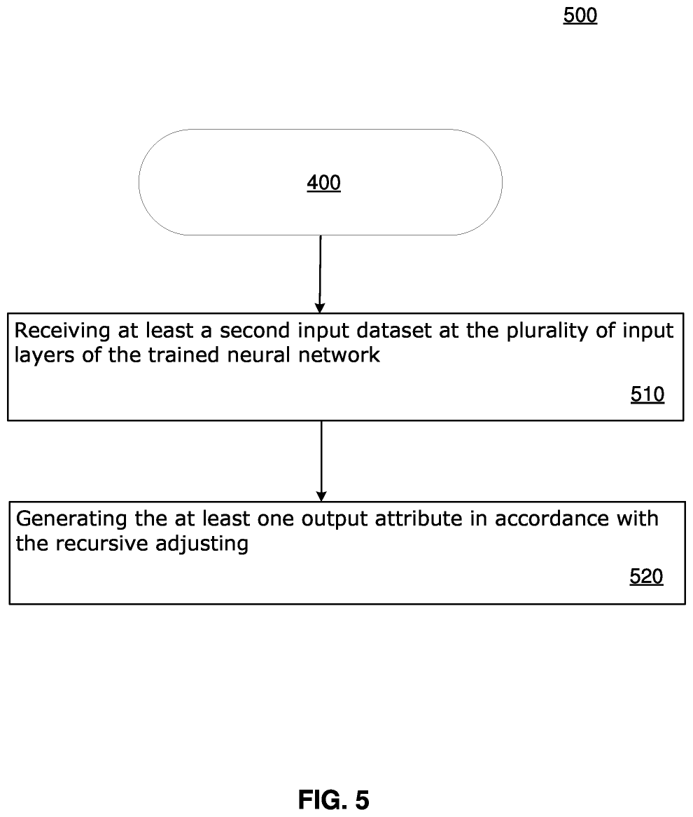

FIG. 5 illustrates, in an example embodiment, method 500 of operation in a cloud-based server computing system for deployment of AI based neural network in digital advertising. Examples of method steps described herein relate to the use of server computing device 101 for implementing the techniques described. Method 500 embodiment depicted is performed by one or more processors 201 of server computing device 101. In describing and performing the embodiments of FIG. 5, the examples of FIG. 1-FIG. 4 are incorporated for purposes of illustrating suitable components or elements for performing a step or sub-step being described.

At step 510, in accordance with method steps as depicted in FIG. 5, deploying the neural network as a trained neural network in accordance with method 400 upon receiving at least a second input dataset at the plurality of input layers of the trained neural network. In embodiments, as the trained neural network is deployed in a digital ad production environment, the neural network can undergo continuous learning and refinement in accuracy as originally trained, and thus benefit from additional and subsequent input datasets provided via production deployments.

At step 520, generating the at least one output attribute in accordance with the recursive adjusting as described with reference to FIG. 4 herein. In embodiments, deploying the neural network as a trained neural network can be based, at least in part, upon attaining respective predetermined data sufficiency thresholds for respective ones of the input dataset layers. A confidence level can be associated with the input attributes data provided to the set of input layers, whereby only input layers having sufficient or high quality input data are selected for activation with one or more intermediate layers in creating the trained neural network. In this manner, the remaining input layers having data sufficiency below the data threshold can be de-activated from neural network node computations. Thus, interconnections between input dataset layers that are below the respective of applicable data sufficiency thresholds may be de-activated from intermediate layers interconnected therewith, assuring that output attribute results can be generated with a higher statistical confidence level in relation to sufficiency of input attributes data.

In some aspects, the data sufficiency threshold can relate to a data source category including a geolocation associated with the source of a given input dataset, a target customer demographic, a recency or temporal proximity of the data collection, a data density and a confidence level associated with digital ad input attribute data provided to input layers in training the neural network in accordance with method 400. In embodiments, with regard to the time proximity of data collection, more recent data can be prioritized, or weighted more heavily, than older data. With regard to the data source category, digital ad data collected in more controlled or monitored contexts may be weighted more heavily, or accorded a higher quality status, than more routinely collected digital ad data. Input data in accordance with some geo-locations may be weighted more heavily than other locations depending on geographic context considerations of a given digital ad.

The data sufficiency, in some embodiments, can relate to a number of digital ad input images, the quality or resolution of the images, or a combination thereof. The data sufficiency, in an embodiment, is a measure of a quality and sufficiency of the digital ad input data for training the neural network to reliably and accurately generate output attributes, in accordance with accumulative and ongoing or continuous training as the neural network is deployed in a production context.

In some embodiments, the method includes dynamically activating one or more of deactivated input attributes dataset layers upon attaining the respective predetermined data sufficiency thresholds associated with the input attributes datasets. In such embodiments, as the input data attributes rise to the level of a respective threshold requirement, the respective input layers which were previously de-activated can now be activated via dynamically linking to establish active nodes of the intermediate layers for compute operations in the neural network and are thus re-engaged in the neural network training or production deployment. Thus, in embodiments, the method can include dynamically activating, as production deployment proceeds, some input dataset layers upon attaining the respective predetermined data sufficiency threshold associated therewith. In further embodiments, dynamically switching on or activating others of previously de-activated or switched off input layers as respective data sufficiency thresholds of training data are reached. The term “dynamically” as used herein refers to actions performed during real-time execution of the neural network in training and also in deployment phases.

In some embodiments, a selected output attribute can be used to identify input attributes of a digital ad associated therewith. Such identified input attributes can be applied in crafting new digital ads likely to meet or exceed desired results in terms of targeted output attributes. In an example embodiment, a return on investment (ROI) metric may be identified as a goal in crafting a new digital ad. The ROI metric could be defined in terms of an absolute dollar value, or as a percentage return on an initial or cumulative cost expenditure associated with digital ad. A predetermined threshold amount of the ROI metric can be assigned, based on which one or more corresponding input attributes associated with being either lesser or greater than the predetermined threshold amount of the ROI metric can be identified from the trained neural network model.

In some embodiments, the method comprises a first neural network training iteration. The method further comprises at least a second neural network training iteration that includes dynamically re-connecting at least one of the remainder input layers to the intermediate layers, responsive to a data density threshold being reached for the at least one of the remainder input layers.

It is contemplated that embodiments described herein extend to individual elements and concepts described herein, as well as for embodiments to include combinations of elements recited anywhere in this application. Although embodiments are described in detail herein with reference to the accompanying drawings, it is to be understood that the invention is not limited to only such example embodiments. As such, many modifications and variations will be apparent to practitioners skilled in the art. Accordingly, it is intended that the scope of the invention be defined by the following claims and their equivalents. Furthermore, it is contemplated that a particular feature described either individually or as part of an embodiment can be combined with other individually described features, or parts of other embodiments, even if the other features and embodiments make no mention of the particular feature. Thus, the absence of describing combinations should not preclude the inventors from claiming rights to such combinations.

What is claimed is:

1. A method of training a machine learning neural network in deploying digital advertising, the method comprising:
receiving a plurality of input datasets at respective ones of a plurality of input layers of the neural network, the neural network being instantiated in one or more processors and comprising an output layer interconnected to the plurality of input layers via a set of intermediate layers, each of the plurality of input datasets being associated with a respective digital advertising (digital ad) input attribute, ones of the set of intermediate layers being configured in accordance with an initial matrix of weights; and
training the neural network in accordance with the respective ones of the plurality of input layers based at least in part upon recursively adjusting the initial matrix of weights by backpropogation in generating, at the output layer, at least one digital ad output attribute in accordance with diminishment of an error matrix computed at the output layer of the neural network.

2. The method of claim 1 wherein the training comprises one of a supervised and an unsupervised learning technique.

3. The method of claim 1 wherein the plurality of input datasets are selected from the group consisting of: a digital ad channel, a digital ad type, a digital target characteristic, a digital ad promotion type, a promotion expiration period, a digital ad cost, a digital ad budget, a digital ad duration, a digital ad timing characteristic, a digital ad text content type and a digital ad image content type.

4. The method of claim 1 wherein the at least one digital ad output attribute comprises at least one of: total cumulative $ sales associated with the digital ad, digital dollar sales revenue, in-venue dollar sales revenue, a number of promotions claimed, a number of promotions redeemed, a promotion redemption rate, a return on investment (ROI) in view of profit versus cost, a profit margin of guest visits, a number of new users that claimed & redeemed, a number of repeat users that claimed & redeemed, a number of visits within a predetermined period after initial redemption visit, dollar sales revenue over a predetermined period after an initial redemption visit, and accumulative revenue dollar value associated with a given customer.

5. The method of claim 1 wherein the machine learning neural network comprises a trained neural network, the input dataset comprises a first input dataset and further comprising deploying the neural network as a trained neural network, the deploying comprising:
receiving at least a second input dataset at the plurality of input layers of the trained neural network; and
generating the at least one output attribute in accordance with the recursive adjusting.

6. The method of claim 5 further comprising deploying the neural network as a trained neural network based at least in part upon attaining respective predetermined data sufficiency thresholds for respective ones of a subset of the set of input layers, and deactivating interconnections between remaining others of the set of input layers and at least some of set of intermediate layers interconnected therewith.

7. The method of claim 6 further comprising dynamically activating at least one of the remaining others upon attaining the respective predetermined data sufficiency threshold associated therewith.

8. The method of claim 6 wherein the predetermined respective data sufficiency threshold relates to at least one of a time proximity of data collection, a target customer demographic and geographic location data associated with the input dataset.

9. The method of claim 5 wherein the at least one output attribute comprises a return on investment (ROI) metric associated with the digital ad, and further comprising:
selecting a predetermined threshold amount of the ROI metric; and
identifying, in accordance with the plurality of input datasets, a plurality of input attributes of a digital ad associated with one of lesser and greater than the predetermined threshold amount of the ROI metric.

10. The method of claim 1 wherein the machine learning neural network comprises one of a convolution neural network and a recurrent neural network.

11. A server computing system comprising:
a processor;
a non-transitory memory storing instructions, the instructions when executed in the processor causing operations comprising:
receiving a plurality of input datasets at respective ones of a plurality of input layers of a neural network, the neural network being instantiated in one or more processors and comprising an output layer interconnected to the plurality of input layers via a set of intermediate layers, each of the plurality of input datasets being associated with a respective digital advertisement (digital ad) input attribute, ones of the set of intermediate layers being configured in accordance with an initial matrix of weights; and
training the neural network in accordance with the respective ones of the plurality of input layers based at least in part upon recursively adjusting the initial matrix of weights by backpropogation in generating, at the output layer, at least one digital ad output attribute in accordance with diminishment of an error matrix computed at the output layer of the neural network.

12. The server computing system of claim 11 wherein the training comprises one of a supervised and an unsupervised learning technique.

13. The server computing system of claim 11 wherein the plurality of input datasets are selected from the group consisting of: a digital ad channel, a digital ad type, a customer demographic target characteristic, a digital ad promotion type, a promotion expiration period, a digital ad cost, a digital ad budget, a digital ad duration, a digital ad timing characteristic, a digital ad text content type and a digital ad image content type.

14. The server computing system of claim 11 wherein the at least one digital ad output attribute comprises at least one of: total cumulative dollar sales associated with the digital ad, digital dollar sales revenue, in-venue dollar sales revenue, a number of promotions claimed, a number of promotions redeemed, a promotion redemption rate, a return on investment (ROI) in view of profit versus cost, a profit margin of guest visits, a number of new users that claimed & redeemed, a number of repeat users that claimed & redeemed, a number of visits within a predetermined period after initial redemption visit, dollar sales revenue over a predetermined period after an initial redemption visit, and accumulative revenue dollar value associated with a given customer.

15. The server computing system of claim 11 wherein the machine learning neural network comprises a trained neural network, the input dataset comprises a first input dataset and further comprising deploying the neural network as a trained neural network, the deploying comprising:
receiving at least a second input dataset at the plurality of input layers of the trained neural network; and
generating the at least one output attribute in accordance with the recursive adjusting.

16. The server computing system of claim 15 further comprising deploying the neural network as a trained neural network based at least in part upon attaining respective predetermined data sufficiency thresholds for respective ones of a subset of the set of input layers, and deactivating interconnections between remaining others of the set of input layers and at least some of set of intermediate layers interconnected therewith.

17. The server computing system of claim 16 further comprising dynamically activating at least one of the remaining others upon attaining the respective predetermined data sufficiency threshold associated therewith.

18. The server computing system of claim 16 wherein the predetermined respective data sufficiency threshold relates to at least one of a time proximity of data collection, a target demographic and geographic location data associated with input dataset.

19. The server computing system of claim 15 wherein the at least one output attribute comprises a return on investment (ROI) metric associated with the digital ad, and further comprising:
selecting a predetermined threshold amount of the ROI metric; and
identifying, in accordance with the plurality of input datasets, a plurality of input attributes of a digital ad associated with one of lesser and greater than the predetermined threshold amount of the ROI metric.

20. A non-transitory computer readable memory storing instructions executable in one or more processors, the instructions when executed in the one or more processors causing operations comprising:
receiving a plurality of input datasets at respective ones of a plurality of input layers of a neural network, the neural network being instantiated in the one or more processors and comprising an output layer interconnected to the plurality of input layers via a set of intermediate layers, each of the plurality of input datasets being associated with a respective digital advertisement (digital ad) input attribute, ones of the set of intermediate layers being configured in accordance with an initial matrix of weights; and
training the neural network in accordance with the respective ones of the plurality of input layers based at least in part upon recursively adjusting the initial matrix of weights by backpropogation in generating, at the output layer, at least one digital ad output attribute in accordance with diminishment of an error matrix computed at the output layer of the neural network.
